(19) United States
(12) Patent Application Publication
(10) Pub. No.: US 2002/0146583 A1
(43) Pub. Date: Oct. 10, 2002

(54) Method of producing textured superconducting oxide bodies by the oxidation/annealing of thin metallic precursors and precursors and superconducting bodies produced by the method

(76) Inventors: Kenneth H. Sandhage, Randolph, MA (US); Eric R. Podtburg, Somerville, MA (US)

Correspondence Address: Mary Rose Scozzafava, Ph.D., Hale and Dorr LLP, 60 State Street, Boston, MA, 02109, US

(21) Appl. No.: 10/045,801

(22) Filed: Jan. 11, 2002

Related U.S. Application Data
(63) Continuation of application No. 08/327,213, filed on Oct. 21, 1994, now abandoned.

(51) Int. Cl. B22F 3/00; B22F 3/26; B22F 5/00; B22F 7/00; C22C 28/00; C22C 29/00; H01S 4/00

(52) U.S. Cl. 428/546; 29/592.1

(57) ABSTRACT

An elongated superconducting body has a core of superconducting oxide grains, and a constraining nonsuperconducting boundary substantially superscribing the superconducting core. The core has thin dimension that is less than or equal to ten times the average length of the grains and the grains are oriented with their a-b crystallographic planes coplanar with a line extending in the longitudinally-extending direction of the core.

### BACKGROUND OF THE INVENTION

This invention relates to superconducting materials in general and, in specific, to textured superconducting oxide bodies and a process for making the same from metallic precursors. It also relates to multifilamentary superconducting oxide bodies with enhanced electrical properties.

Superconductors are materials having essentially zero resistance to the flow of electrons at temperatures below a critical temperature, T_{c}. It is known that certain metal oxides exhibit superconductivity at relatively high temperatures, e.g. above 10 degrees Kelvin. For example, one group of known superconducting metal oxides has the general formula La₂₋ₓMₓCuO_{4-y} (where M is an alkaline earth element such as Ba, Sr, etc.) Other groups include, but are not limited to:

1) RₐBa_{b}Cu_{c}O_{y} (where R can be one or a combination of Y, Yb, Er, Ho, Eu, Dy, Gd, La, Pr, Sm, Nd, Ca or other rare earth elements and the subscripts a, b, and c are in the ratio 1:2:3, 2:4:7, 1:2:4, or, more generally, n:2n:3n+1, where n=1, 2, 3, . . . );

2) (M₁₋ₓQₓ)ₐL_{b}Ca_{c}Cu_{d}O_{y} (where M can be one or a combination of Bi, and/or Tl; Q can be Pb, Sb; L can be one or a combination of Sr, Ba, or other alkaline earth species; x=0 or x>0; and the ratio of a:b:c:d can be 2:2:n:n+1, 1:2:n:n+1, 1:1:n:n+1, and 2:1:n:n+1 wherein n=0, 1, 2, 3 . . . );

3) PbₐSr_{b}M_{c}Cu_{d}Oₓ (where M can be one or a combination of Y, La, Pr, Nd, Eu, Dy, Ho, Tm, Lu, or other rare earth elements, Sr, Ca, or other alkaline earth elements, and the a:b:c:d ratio can be 2:2:1:3)

4) BaPb₁₋ₓBiₓO₃ (where x>0), and

5) BaₓK₁₋ₓBiO₃ (where x>0).

While each of the above metal oxides contains oxygen, it should be noted that “oxides” as used herein do not necessarily include oxygen. Oxidation is the process by which a metal element is converted from a lower to a higher valence state. A higher valence state is achieved when an element has given up at least one valence electron. Accordingly, an oxide is defined herein as a compound in which a metal species has been placed in a higher valence state. Examples of oxides include, but are not limited to, sulfides, halides, carbides, nitrides, carbonates and metal-oxygen compounds. Metals or alloys can be oxidized by heating them in an oxidizing atmosphere (e.g., in atmospheres containing O₂, S₂, N₂, or CO₂). They can also be oxidized by applying an electric potential.

Superconducting oxides, as is true for oxides in general, are susceptible to brittle fracture during loading. N. McN. Alford, J. D. Birchall, W. J. Clegg, M. A. Harmer, K. Kendall, and D. H. Jones, “Physical and Mechanical Properties of YBa₂Cu₃O₇₋ₓ Superconductors,” J. Mat. Sci., Vol. 23, No. 3, pp. 761-8, 1988. Since the electrical conductivity of a superconducting oxide body is degraded if cracks are present in the conduction path, a reduction in the tendency for crack propagation in a superconducting body should decrease the sensitivity of the superconductor to applied stress.

Composites of oxide and metal are less susceptible to catastrophic brittle fracture than are pure oxides. Several theories have been proposed to explain the improved mechanical properties of an oxide and metal composite, including crack bridging, crack deflection, crack blunting, and crack shielding. See F. Erdogan, P. F. Joseph, “Toughening of Ceramics through Crack Bridging by Ductile Particles,” J. Am. Ceram. Soc., Vol. 72, No. 2, pp. 262-70, 1989; A. G. Evans, R. M. McMeeking, “On the Toughening of Ceramics by Strong Reinforcements,” Acta Metall., Vol. 34, No. 12, pp. 2435-2442, 1986; and L. S. Sigl, P. A. Mataga, B. J. Dalgleish, R. M. McMeeking, and A. G. Evans, “On the Toughness of Brittle Materials Reinforced with a Ductile Phase,” Acta Metall., Vol. 36, No. 4, pp. 945-953, 1988. According to these theories, the microstructure or morphology of the oxide and metal composite determines the composite's tendency to crack. For example, a microstructure that is particularly effective in enhancing the resistance to crack propagation by a crack-bridging mechanism is a composite consisting of large, interconnected metal particles uniformly distributed about an oxide phase.

One method of producing a composite of superconducting oxide and metal is to first form a precursor alloy that includes the metallic elements of the desired superconducting oxide and at least one other metal and then oxidize the alloy to form the superconducting oxide. (See for example, U.S. Pat. No. 4,826,808 “Preparation of Superconducting Oxides and Oxide Metal Composites,” by Yurek, et al, incorporated herein by reference). The alloy is formed with a noble metal element (noble in the sense that its oxide is thermodynamically unstable under the reaction conditions employed to oxidize the alloy). A noble metal-bearing alloy can be oxidized under conditions that convert certain metallic elements of the alloy to the superconducting oxide without oxidizing the noble metal. The noble metal precipitates as a finely divided, substantially pure metal phase rather than as a second oxide phase. The noble metal is thus intimately mixed with the superconducting oxide, thereby improving the mechanical properties (e.g., strength, ductility) of the composite.

In general, the fracture toughness of the oxide/metal composite increases as the amount of metal in the composite increases. However, an increase in the volume fraction of metal will result in a decrease in the volume fraction of superconducting oxide, which can result in a reduced supercurrent carried by the composite. If the amount of metal becomes sufficiently large, a continuous conduction path through the superconducting oxide grains can not be maintained and the composite will no longer be superconducting. Thus, a trade-off between superconducting properties and mechanical properties must be made in optimizing the amount of metal phase in a composite with a random distribution of metal and oxide.

The morphologies of the oxide and metal components, at a given volume fraction of metal, also play an important role in determining the electrical properties of the composite. As discussed above, the oxide grains must be of sufficient concentration to provide a continuous conduction path or the composite will not transport supercurrent. Further, the orientation of the oxide grains affects the electronic properties of the composite. More specifically the critical currents of superconducting oxides are greater in materials in which oxide grains are crystallographically aligned in a preferred direction.

For example, highly-oriented thin films of YBa₂Cu₃O₇₋ₓ have exhibited transport critical current densities of 4×10⁵ and 6.5×10⁴ A/cm² at 77 degrees Kelvin (“K”) in applied magnetic fields of 2 and 27 Tesla (“T”), respectively. The superconducting oxide grains in such films are aligned with the crystallographic c direction perpendicular to the plane of the film. K. Watanabe, H. Yamane, H. Kurosawa, T. Hirai, N. Kobayashi, H. Iwasaki, K. Noto, and Y. Muto, “Critical Currents at 77.3 K under Magnetic Fields up to 27 T for an Y—Ba—Cu—O Film Prepared by Chemical Vapor Deposition,” Appl. Phys. Lett., Vol. 54, No. 6, pg. 575, 1989. Similarly, thin films of highly-oriented Bi_{2.2}Sr₂Ca₁Cu₂O₈₊ₓ have yielded transport critical current densities of 10⁵ A/cm² at 61 K in the earth's field. M. Hong, J. Kwo and J. J. Yeh, “High Critical Current Superconducting Bi—Sr—Ca—Cu—O Films,” Appl. Phys. Lett., 1988.

Bulk, crystallographically-oriented bodies of YBa₂Cu₃O₇₋ₓ have been produced by a directional solidification process known as “melt-textured growth.” Such oriented, bulk superconductors have yielded transport critical current densities (J_{c}) of 1.7×10⁴ and 4×10³ A/cm² at 77 K in applied fields of 0 and 1 T, respectively. S. Jin, T. H. Tiefel, R. C. Sherwood, R. B. van Dover, M. E. Davis, G. W. Kammlott, R. A. Fastnacht, and H. D. Keith, Appl. Phys. Lett., Vol. 52, pg. 2074, 1988. In contrast, bulk unoriented bodies of YBa₂Cu₃O₇₋ₓ have produced current densities on the order of only 102-103 A/cm² at 77 K in zero appled field. The J_{c} values of such unoriented YBa₂Cu₃O₇₋ₓ bodies exhibit a dramatic reduction upon application of magnetic fields. J. M. Seuntjens, D. C. Larbalestier, J. Appl. Phys., Vol. 67, 1990, pg. 2007. Thus, it is desirable to provide crystallographically-oriented superconducting oxide bodies.

One possible explanation for the improved electrical performance of superconductors with preferred crystallographic orientation is a reduction in structural disorder at grain boundaries. Dimos et al. have observed that the critical current density across a grain boundary in a bicrystal of YBa₂Cu₃O₇₋ₓ decreased as the misorientation angle of the grains increased. The drop in critical current with grain misorientation may be due to an increase in the structural disorder of the grain boundary, which, in turn, reduces the flow of supercurrent across the grain boundary. D. Dimos, P. Chaudhari, J. Mannhart, and F. K. LeGoues, in “Orientation Dependence of Grain Boundary Critical Currents in YBa₂Cu₃O₇₋ₓ Bicrystals, “Phys. Rev. Lett., Vol. 61, No. 2, pg. 219, 1988 and D. C. Larbalestier, S. E. Babcock, X. Cai, L, Cooley, M. Daeumling, D. P. Hampshire, J. McKinnell and J. M. Seuntjens, Proceedings of the Tokai University Symposium on Superconductivity, World Scientific Press, November 1988. It is also known that there exists an anisotropy in superconduction for high-T_{c} oxides, with the greatest supercurrent flowing in directions lying in the crystallographic a-b planes of the superconducting oxide grains. Thus, it is desirable to obtain bodies with superconducting oxide grains oriented such that the degree of misalignment between neighboring grains is minimized and such that crystallographic a-b planes in the grains are aligned with the operationally-required direction of current flow.

YBa₂Cu₃O₇₋ₓ superconductors are composed of a crystal unit cell having a long dimension in the c direction and shorter dimensions in the a and b directions, as shown in FIG. 1. In this crystal, the c dimension is about 11.7×10⁻¹⁰ m, the b dimension is about 3.88×10⁻¹⁰ m and the a dimension is about 3.82×10⁻¹⁰ m. The c dimension of the unit cell is about three times longer than the a and b dimensions. Pb—Bi—Sr—Ca—Cu—O-based high temperature superconductors are similar in that the unit cells possess a c dimension that is long relative to the other dimensions.

It is known that a crystallographic growth rate anisotropy exists in Y—Ba—Cu—O and Pb—Bi—Sr—Ca—Cu—O-based superconductors, such that the superconducting oxide grains grow to become relatively long in directions parallel to the a-b plane of the unit cell and relatively short in the c direction. (Thus, the long dimension of the unit cell becomes the short dimension of the oxide grain.) That is, the growth of the superconducting grain is most rapid in the a-b plane, but not in the c direction. The growth anisotropy results in aspected grains with a thin dimension as shown schematically in FIG. 2. It should be noted that FIG. 2 is not to scale.

It is also known that during annealing and normal grain growth, large grains tend to consume smaller grains in order to minimize the total free energy associated with the grain boundaries. M. Hillert, Acta Met., Vol. 13, pg. 227, 1965

If, during oxidation/annealing, the growth of the high-T_{c} superconducting oxide grains is in effect constrained in one or two dimensions and unconstrained in the other dimension(s), then the formed grains having the longest dimensions are those oriented with the fast-growth crystallographic directions (directions parallel to the a-b planes in high-T_{c} oxides) parallel to the “unconstrained” dimension(s). As discussed above, it is desirable to obtain high-T_{c} oxide superconducting bodies having the fast-growing a-b planes of the grains aligned parallel to the direction of bulk current flow. The grains that are oriented with a-b planes parallel to a desired dimension grow to become relatively long and, by the process of normal grain growth, will eventually consume smaller grains that are not so oriented, which are limited in length. Thus, it is possible to obtain a preferred grain alignment by effectively limiting the anisotropic growth of high-T_{c} oxide grains. (As used herein and in the claims, the “length” of an oxide grain means the size of that grain's greatest dimension.)

One known method for obtaining superconducting oxide structures with limited dimensions other than in the direction of bulk current flow is to make oxide filaments according to what is known as the “oxide-powder-in-tube” method. In this method, superconducting oxide powder is placed in a tube, usually made of silver. After sealing, the filled tube is deformed into a thin ribbon or a narrow wire. The deformation step is usually followed by a high temperature anneal to allow for sintering of the oxide grains. Unfortunately, it is difficult to obtain thin ribbons or wires with a uniformly thin core by this method. For example, Osamura, et. al report that “it is difficult to ensure homogeneous deformation” for silver-sheathed Pb—Bi—Sr—Ca—Cu—O tapes with an oxide core thinner than 20 microns. K. Osamura, S. Oh, S. Ochiai, “Effect of Thermomechanical Treatment on the Critical Density of Ag Sheathed B (Pb) SCCO Tapes,” Superconductor Science and Technology, Vol. 3, 1990, pg. 143. The reason for such nonhomogeneous deformation is that the brittle oxide core and ductile metallic sheath behave differently during deformation. Superconducting oxides have been found to deform in a brittle manner, even at strain rates of as low as 10⁻⁴ sec⁻¹ and temperatures of 800° C. M. J. Kramer, L. S. Chumbley, R. W. McCallum, “Analysis of Deformed YBa₂Cu₃O₇₋ₓ,” Preprint Submitted to J. of Mat. Sci., 1989. Conversely silver deforms in a ductile manner under such conditions. This difference in deformation behavior leads to gradients in local flow stress between the brittle core and ductile sheath that limit the workability of the oxide/metal composite tube. R. N. Wright, R. M. German, D. B. Knorr, R. K. MacCrone, K. Rajan, and W. Z. Misiolek, “Mechanical Considerations in the Processing of High T_{c} Superconductors,” Presented at the annual TMS meeting, Feb. 21, 1990, Anaheim, Calif.

Very fine and uniform superconducting filaments have been produced in wires of low temperature, metallic superconductors (to be distinguished from high temperature, oxide superconductors) by the deformation of metallic precursors. For example, in the “bronze” process, niobium rods are placed in axial holes that are drilled in a larger-diameter bronze rod. H. Hillmann, “Fabrication Technology of Superconducting Material,” in Superconductor Materials Science: Metallurgy, Fabrication, and Applications, ed. S. Foner, B. B. Schwartz, 1981, Plenum Press, New York, pg. 342. This bronze-niobium composite is extruded to a suitable diameter. Such composite rods are bundled and assembled in another bronze tube which, again, is worked down. The multifilamentary composite is then annealed so as to produce the low temperature superconductor, Nb₃Sn, with the Sn (tin) having been provided by the bronze. Such a process has been used to obtain uniform superconducting filaments that are 3-5 microns in diameter. However, these Nb₃Sn filaments are not superconducting at temperatures above 20° K.

Fine filaments (in monofilamentary or multifilamentary bodies) of metallic precursors to high-T_{c} superconducting oxides have not been used, to date, as a means of obtaining aligned grains of high-T_{c} superconducting oxide with improved superconducting properties.

### OBJECTS OF THE INVENTION

Thus, the several objects of the invention include: to provide a high temperature superconducting structure that resists cracking and has excellent superconductivity characteristics where the superconducting crystals are crystallographically oriented so that a direction of preferred superconductivity of the crystal is coplanar with the operationally-required direction of supercurrent; to provide such a superconducting structure having minimal misorientation angle between superconducting oxide grains; to provide high temperature superconducting structures of a thickness less than 20 microns and preferably as thin as a few microns; to provide high temperature oxide superconducting structures with oxide grains that possess a long dimension that is larger than at least one-tenth of one or more dimensions of the structure; to provide such a superconducting body in the form of wires, rods, tapes and sheets; and to provide a method for the fabrication of such a superconductor, which method is reliable and reproducible.

### SUMMARY OF THE INVENTION

The method of the invention comprises the steps of combining the metallic elements that will be oxidized to form the superconducting oxide, placing the combined metallic elements in a metallic container, deforming the container and contents to substantially reduce its diameter and increase its length so that the deformed precursor is very thin in at least one dimension perpendicular to its length. When the desired size and shape have been achieved, the deformed container is heat treated such that the metallic elements of the superconducting oxide are oxidized to form a superconductor. The heat treatment is conducted so as to form superconducting oxide grains that possess at least one grain dimension that is larger than one-tenth of the thin dimension(s) of the superconducting body. The composite has both excellent mechanical and superconducting properties.

During heat treatment, the size of the growing oxide grains is constrained in a direction (or directions) parallel to the thin dimension (or dimensions) of the body. The grains will be prevented from growing large in that direction (or directions) and any directions not parallel to the non-thin dimension (or dimensions) of the body. Further, due to the anisotropy in growth rate, any grains aligned with the crystallographic c axis parallel to an unconstrained direction(s) will be relatively small compared to fast-growing neighbors that are oriented with crystallographic a-b planes parallel to the unconstrained direction(s). The relationship between the anisotropies of growth rate and superconductivity are such that the fast-growth plane of the grains (the crystallographic a-b planes) is coplanar with the preferred plane of superconduction. Due to normal grain growth, the larger grains, oriented as desired for operational purposes, tend to consume the smaller grains, which are not oriented as desired. Thus, the natural anisotropies of superconduction and grain growth of the high T_{c} oxides are used, along with the geometric constraint provided by deformation of the metallic precursor and subsequent heat treatment, to generate a superconducting oxide body with desirable superconducting properties.

The interface between the superconducting oxide and the nonsuperconducting metallic container may also play a role in the mechanism for alignment of the superconducting oxide grains during heat treatment. If the free energy associated with the superconducting oxide-metal container interface varies with the crystallographic orientation of the superconducting oxide phase, then nucleation of the superconducting oxide phase at the oxide/metal container interface may yield superconducting oxide grains with a preferred crystallographic orientation (e.g., c axis perpendicular to the plane of the oxide-metal container interface). Whether the mechanism of preferred superconducting oxide orientation near an interface results from either the constrained volume of the superconductor or the interface between the superconducting oxide and the metallic container individually, or in combination, a reduction in at least one dimension of the oxide precursor layer perpendicular to the oxide precursor-metal interface enhances the fraction of superconducting oxide grains exposed to the interface, which, in turn, can enhance the fraction of superconducting oxide grains with preferred crystallographic orientation.

A first preferred embodiment of the invention is an elongated superconducting body comprising a core of superconducting oxide grains, the core having at least one thin first dimension that is less than or equal to 10 times the average length of the superconducting oxide grains of a first significant fraction in the core and a constraining non-superconducting boundary member substantially circumscribing the superconducting core.

A second preferred embodiment of the invention is an elongated superconducting body comprising at least one high temperature superconducting assembly, each assembly having at least one innermost superconducting assembly, each innermost superconducting assembly comprising a plurality of cores of high temperature superconducting oxide grains, the cores having at least one thin first dimension that is less than or equal to 10 times the average length of the superconducting oxide grains of a first significant fraction in the cores, each core also being substantially circumscribed by a constraining non-superconducting boundary member and a constraining non-superconducting boundary member substantially circumscribing the plurality of superconducting cores.

A third preferred embodiment of the invention is a metallic precursor body for heat treating to form an elongated superconducting oxide body the precursor comprising a core of the metallic elements of the superconducting oxide in substantially the stoichiometric proportions to form the superconducting oxide, said core having at least one thin first dimension that is less than or equal to 10 times the average length of superconducting oxide grains of a first significant fraction that form upon heat treatment of the metallic precursor body and a constraining non-superconducting boundary member substantially circumscribing the metallic precursor core.

A preferred instance of the method of invention is a method of fabricating an elongated superconducting body comprising the steps of providing a metallic precursor core of the metallic elements of said superconducting oxide in substantially the stoichiometric proportions to form the superconducting oxide; providing a constraining non-superconducting boundary member substantially circumscribing the metallic precursor core; deforming the combined metallic precursor core and boundary member to an elongated shape, having at least one thin first dimension; heat treating the deformed combined precursor core and boundary member so as to produce a first significant fraction of oxide superconductor grains of the precursor core having an average length that is greater than one-tenth said thin first dimension of the deformed metallic precursor core.

A second preferred instance of the method of the invention is a method of fabricating an elongated, superconducting body having at least one assembly of superconducting cores comprising the steps of repeating the following steps (i) and (ii) until a predetermined number of cores are prepared: (i) providing a metallic precursor core of the metallic elements of the superconducting oxide in substantially the stoichiometric proportions to form the superconducting oxide; and (ii) providing a constraining non-superconducting boundary member substantially circumscribing the metallic precursor core; associating a predetermined number of contained cores into at least one innermost assembly of cores; for each at least one innermost assembly, providing a constraining non-superconducting boundary member sized to substantially circumscribe the assembled contained cores; deforming each at least one innermost assembly so that it becomes thinner in at least one first dimension; repeating the following steps (i)-(iv) until the predetermined degree of nesting is achieved: (i) associating a predetermined number of deformed assemblies of predetermined degrees of nesting in a predetermined configuration; (ii) providing a constraining non-superconducting boundary member sized to substantially circumscribe the associated deformed assemblies; (iii) packing the associated deformed assemblies into the circumscribing boundary member to form an intermediate assembly of greater degree of nesting than the deformed assemblies being packed; and (iv) deforming the greater degree intermediate assembly so that it becomes thinner in at least one first dimension; and heat treating said deformed assembly of predetermined degree nesting so as to produce a first significant fraction of superconducting oxide grains of at least one of the precursor cores, the superconducting oxide grains having an average length that is greater than or equal to one-tenth the at least one thin first dimension of the deformed cores.

A third preferred embodiment of the method of the invention is a method of fabricating a metallic precursor for an elongated, superconducting body having at least one assembly of superconducting cores comprising the steps of repeating the following steps (i) and (ii) until, a predetermined number of cores are prepared (i) providing a metallic precursor core of the metallic elements of the superconducting oxide in substantially the stoichiometric proportions to form the superconducting oxide; and (ii) providing a constraining non-superconducting boundary member substantially circumscribing the metallic precursor core; associating a predetermined number of contained cores into at least one innermost assembly of cores; for each at least one innermost assembly, providing a constraining non-superconducting boundary member sized to substantially circumscribe the assembled contained cores; deforming each at least one innermost assembly so that it becomes thinner in at least one first dimension; and repeating the following steps (i)-(iv) until the predetermined degree of nesting is achieved: (i) associating a predetermined number of deformed assemblies of predetermined degrees of nesting in a predetermined configuration; (ii) providing a constraining non-superconducting boundary member sized to substantially circumscribe the associated deformed assemblies; (iii) packing the associated deformed assemblies into the circumscribing boundary member to form an intermediate assembly of greater degree of nesting than the deformed assemblies being packed; and (iv) deforming the greater degree intermediate assembly so that at least one first thin dimension of at least one of the metallic precursor cores is less than or equal to 10 times the average length of superconducting oxide grains of a first significant fraction that form upon heat treatment of the metallic precursor cores.

### BRIEF DESCRIPTION OF THE FIGURES OF DRAWING

FIG. 1 is a schematic drawing of a typical unit cell of the superconducting oxide, YBa₂Cu₃O₇₋ₓ, showing that the longest dimension of the unit cell is parallel to the c axis.

FIG. 2 is a schematic drawing of a growing superconducting oxide grain, showing that the grain grows most rapidly in directions parallel to the a-b plane.

FIG. 3 is a two-dimensional schematic drawing of growing superconducting oxide grains constrained not to grow long in one direction.

FIG. 4 is a schematic diagram showing a laminated structure of superconducting and non-superconducting noble metal composite.

FIG. 5 is a schematic diagram showing a container of an inert material containing a superconducting material.

FIG. 6 is a schematic diagram showing a container, circumscribing a number of containers such as shown in FIG. 5, deformed to reduce their diameter and increase their length.

FIG. 7 is a schematic diagram showing a container, circumscribing a number of nested containers such as shown in FIG. 6, deformed to reduce their diameter and increase their length.

FIG. 8 is a flow chart, showing schematically the method of the invention, as applied to a single superconducting body containing the YBa₂Cu₃O₇₋ₓ superconductor.

FIG. 9 is a two-dimensional schematic showing high current transport paths across large area grain boundaries, and around small area grain boundaries, in a superconductor with c-axis aligned grains.

FIG. 10 is a flow chart showing schematically the method of the invention as applied to a plurality of nested superconducting bodies.

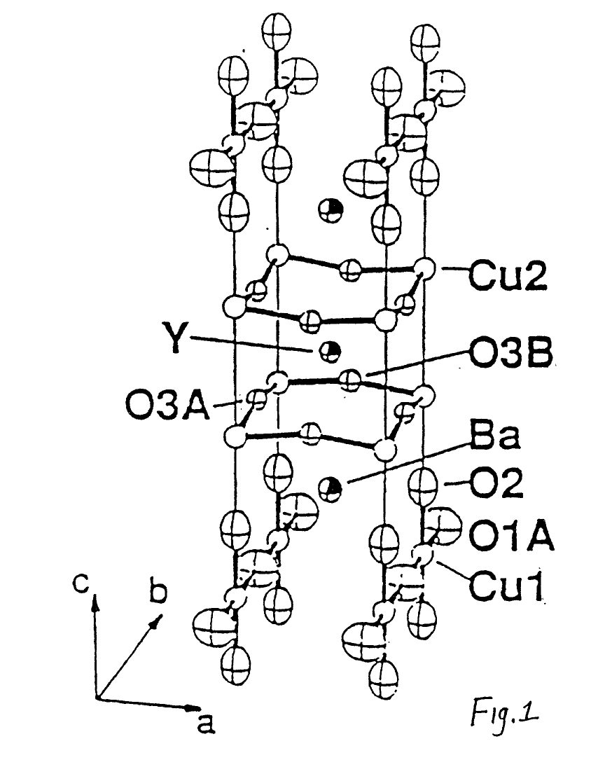

### DESCRIPTION OF THE PREFERRED EMBODIMENTS OF THE INVENTION

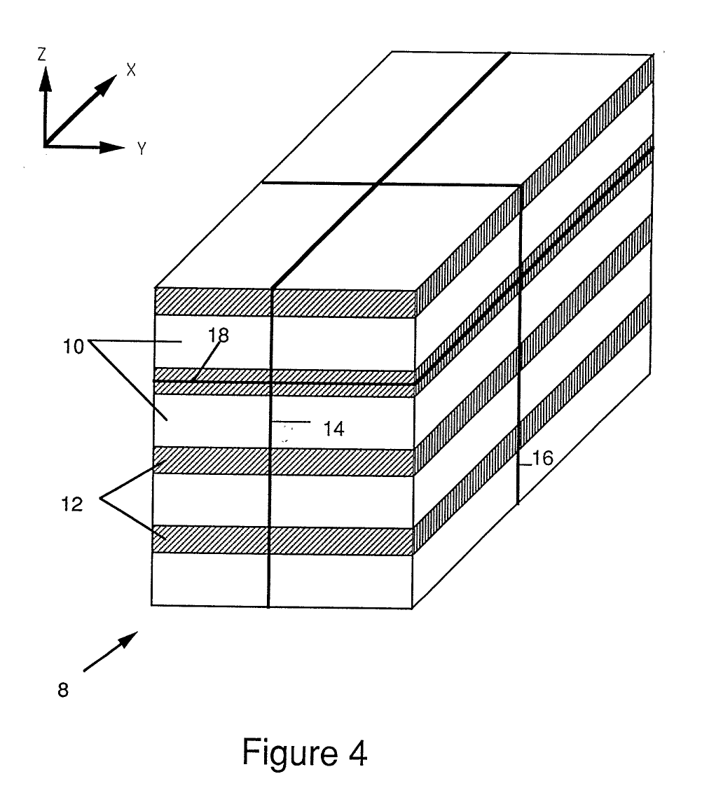

The invention will be understood with reference to the following detailed discussion and the figures of the drawing. FIG. 4 shows schematically the general case of a micro-laminate 8 of layers of pure metal 10 separated by thin layers of pure superconducting oxide 12. A laminate provides the basic geometry for establishing a crack-resistant superconducting body with a high degree of superconducting oxide grain alignment. The superconducting body is used such that the most supercurrent flows in either direction x or y and generally in the x-y plane. It is not necessary that supercurrent flow in the z direction.

It will be understood that a crack such as 14 would disrupt current flow in the y direction. A crack such as 16 would disrupt current flow in the x direction. Crack propagation such as indicated at 14 or 16 is particularly difficult through a metal-superconducting oxide laminate since the crack would have to pass through relatively ductile, crack resistant, pure metal layers 10. If a crack were to initiate in any single layer of superconductor, it is unlikely that it could propagate to another layer of superconductor. Crack propagation can still occur along any direction located in the x-y plane of the oxide layers, such as 18. However, a few cracks of the type 18 do not completely disrupt current flow through the entire micro-laminate 8. Thus, the electrical conductivity of micro-laminate 8 can be less sensitive to applied stress than for a pure oxide.

The laminated superconducting oxide-metal composite also provides an advantage in electrical properties over a non-laminated composite due to the higher degree of connectivity of superconducting grains in the laminate. The minimum concentration of superconducting grains in a composite necessary to maintain a continuous superconducting path is known as the “percolation limit.” In micro-laminate 8, the superconducting oxide grains are concentrated in dense bands. Accordingly, the likelihood that any oxide grain will make contact with a nearby oxide grain is greater than if the oxide grains were randomly distributed in a noble metal matrix. In other words, the local concentration of the superconducting oxide grains in micro-laminate 8 is higher than for a more random microstructure so that the percolation limit can be exceeded in the laminate even with a large volume fraction of metal. Hence, micro-laminate 8 may contain a relatively large volume fraction of metal, as compared to composites having a random blend of metal and oxides, without losing its superconducting properties.

A preferred embodiment of the invention is shown in FIG. 7. In this case, the laminate takes the form of multiple, nested containers. An outside container 60 is made of silver or some other inert, deformable metal. By inert, it is meant a metal that will not degrade the superconductor. It may be that the inert metal is the same as a noble metal, discussed above, but that is not necessarily the case. The noble metal can include one or more of the following: Ag, Au, Pd, Pt, Rh, Os, Ru, Ir, Hg and Cu. It may also be a composite of such metal and an oxide. Nested within the outside container 60 are a plurality, in this case seven, of intermediate container assemblies 58a-58g. The outside container 60 and intermediate container assemblies are sized and shaped so that each intermediate container assembly contacts another intermediate container assembly and/or the outside container 60 such that there can be substantially no relative radial or circumferential motion of the intermediate container assemblies relative to each other without substantially deforming any container assemblies. For example, the intermediate container assemblies may be shaped so as to possess hexagonal cross-sections.

A representative intermediate container assembly 58, for example 58a, is shown schematically in FIG. 6. Intermediate container 70 is made of an inert, deformable metal. Nested within the intermediate container 70 are a plurality, in this case seven, of interior container assemblies 68a-68g. The interior container assemblies 68a-68g are sized and shaped with respect to intermediate container 70 so that each interior container assembly contacts another interior container and/or the intermediate container 70 such that there can be substantially no relative radial or circumferential motion of the interior containers relative to each other without deforming any containers.

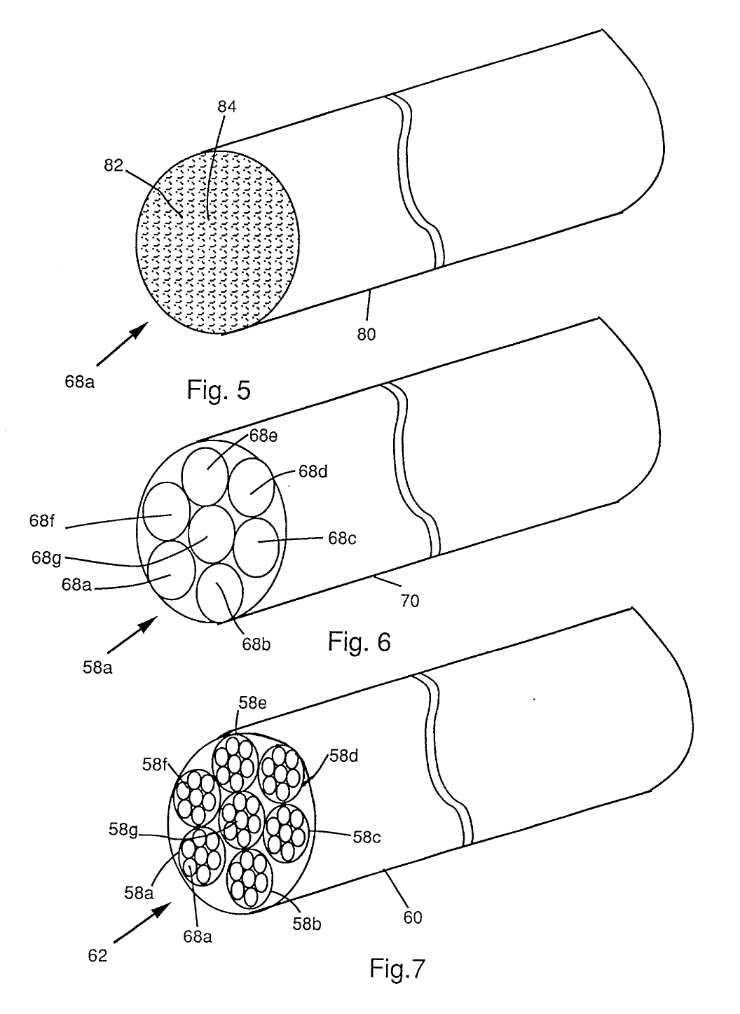

A representative interior container assembly 68, for example 68a, is shown schematically in FIG. 5. Intermediate container 80 is also made of an inert, deformable metal. Packed within the interior container 80 is a superconducting oxide 82. (A noble metal phase 84 is also shown, although this is not necessary and the superconducting oxide phase 82 can take up the entire space.)

Thus, returning to FIG. 7, the nested structure includes a plurality (in this case 49 (7×7)) of essentially parallel, superconducting bodies, separated from each other by inert containers, all packed within a circumscribing, inert container. Thus, a nested laminate is formed. The body is preferably used to conduct supercurrent along its long dimension indicated by arrow E.

It will be understood by one of ordinary skill in the art that while the embodiment shown in FIG. 7 consists of an outside container 60, intermediate containers 58 and interior containers 68, it is within the scope of the invention that there be a large plurality of degrees, or levels of intermediate nesting. In other words, there can be an outside container circumscribing a plurality of primary intermediate containers, each primary intermediate container circumscribing a plurality of secondary intermediate containers, each secondary intermediate container circumscribing a plurality of tertiary intermediate containers, and so on, with the innermost intermediate containers circumscribing a plurality of interior containers. The degree of nesting depends upon the desired performance characteristics, e.g. supercurrent capacity; resistance; normal current capacity; physical dimensions; etc., as well as the deformability of the containers, e.g. ductility, necking, etc. Further it may be desirable that certain sets of a given degree of nesting may be packed differently from other sets of the same nominal degree. For instance, it is possible for assembly 58a to be made up of 3 degrees of nested assemblies while 58b is made up of 4 degrees of nested assemblies.

Further, it will be understood by one of ordinary skill in the art that while the embodiment shown in FIG. 7 consists of an outside container 60, intermediate containers 58, and interior containers 68, all of which possess circular cross-sections, it is within the scope of the invention that the cross-sectional shapes of these nested container can vary from circular. Possible cross-sectional shapes of the nested containers include, but are not limited to, circular, elliptical, hexagonal, triangular, rectangular, and square.

It will be understood by those of ordinary skill in the art that the nested structure shown in FIG. 7 provides the crack resistant property discussed above with respect to the laminate shown in FIG. 4, to a high degree. Although it may be possible for a crack to arise in any one of the superconductor bodies 68, even for the full length of the conductor, it would be difficult for such a crack to propagate to another superconductor body. To do so, it would have to pass through the metal container 80 surrounding the superconductor, through a metal container 80 surrounding another superconductor, e.g. 68b, and through that superconductor, and so on. This would be difficult owing to the tough, crack-resistant nature of the metal containers dispersed throughout the laminate.

It is possible to further enhance the crack resistance by adding a noble metal to the precursor, such that when the precursor is oxidized, the noble metal remains a metal, rather than oxidizing to become a ceramic. This noble metal phase is indicated at 84 in the superconductor 82 shown in FIG. 5. The additional metal matrix interspersed with the superconducting ceramic enhances the resistance to crack propagation over that of the pure superconductor.

It will be understood that the superconductor (and noble metal, if present) filling up the interior containers may be prepared in various manners.

For instance, the superconductor can be prepared by oxidizing a shaped metallic precursor. The metal elements are combined in the precursor to achieve the desired metal ratio in the superconducting oxide, once the proper heat treatment is applied. The metal elements may be combined to form a homogeneous metallic precursor by solid-state (e.g., mechanical alloying and/or blending of the metal elements), liquid-state (e.g., melt alloying), or vapor-state (e.g., plasma, evaporation, ablation, etc.) techniques. The metallic precursor may be shaped by a variety of solid-state (e.g., deformation, machining), liquid-state (e.g., casting of a molten alloy into a mold, rapid solidification into a powder or tape, electrolytic deposition), or vapor-state methods (e.g., evaporation or sputtering onto a shaped substrate). A combination of shaping methods may also be used. For example, substrates coated with a metallic precursor by sputtering can be packed into an inert metallic container and deformed into a desired shape.

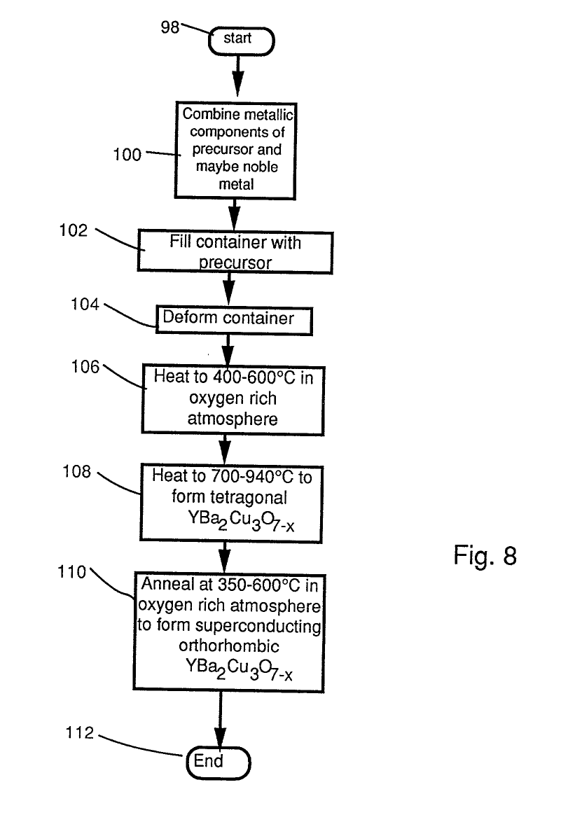

The process of the invention will be understood with reference to FIG. 8 showing schematically the process of the invention in flow chart form. The process starts at 98. The metallic precursor elements are combined 100. The metallic precursor may include noble metal elements. A container is filled with the metallic precursor 102. The filled container is deformed into the desired shape 104. Possible deformation processes include, but are not limited to, drawing, rolling, extrusion, forging, pressing, swaging, etc. The deformation may also be conducted at elevated temperature. The packed container can thus be deformed into a rod, wire, tape, sheet, etc. Because the precursor and the container are both metallic they can both be simultaneously deformed without the inhomogeneity problems discussed above with respect to the “oxide-powder-in-tube” method. Preferably, the deformation is such that it results in a precursor region that is generally elongated, and very thin in at least one dimension perpendicular to the direction of elongation. Once the desired shape is obtained, the deformed container and precursor is heat treated to convert the precursor into the superconductor. A long, thin configuration enhances the crystallographic alignment of the formed superconductor during heat treatment, as discussed below.

For example, metallic Y, Ba and Cu precursor can be mechanically alloyed, placed in a container, and deformed so as to yield metallic precursor that is thin in at least one dimension perpendicular to the direction of elongation. The deformed container is then typically heated 106 to 400-600° C. in an oxygen bearing atmosphere to completely oxidize the metals. It is possible to heat treat the container at temperatures as low as 200° C. However, the kinetics of oxidation are very slow at this temperature. The container is then heated 108 to 700-940° C. to form tetragonal YBa₂Cu₃O₇₋ₓ. The time at 700-940° C. should be sufficiently long so as to produce a significant fraction of YBa₂Cu₃O₇₋ₓ grains with a length that is greater than one-tenth the thin dimension(s) of the unoxidized filament. In fact, the larger the relative length of the average grain, the better; however, it is believed that the advantages of the invention can be obtained if a significant fraction of YBa₂Cu₃O₇₋ₓ grains possess a length that is greater than one-tenth the size of the thin dimension. The container is annealed 110 at 350-600° C. in an oxygen rich atmosphere to form the superconducting orthorhombic version, YBa₂Cu₃O₇₋ₓ. A typical thin dimension for the metallic precursor that may be suitable for many applications is 1×10⁻³ cm.

The fraction of such long grains is considered to be significant if it is greater than or equal to the percolation limit for superconduction along a path composed solely of such long grains. (The volume fraction of randomly-oriented, spherical grains required for electrical percolation in three dimensions is called the percolation limit and is estimated to be about 0.15. H. Scher, R. Zallen, J. Chem. Phys., Vol. 53 (1970), pg. 3759).

In this case, a significant fraction of YBa₂Cu₃O₇₋ₓ grains should possess a length that is greater than or equal to 1×10⁻⁴ cm. In a preferred embodiment, a significant volume fraction is greater than or equal to 0.15 and in a most preferred embodiment, greater than or equal to 0.5. The reason that having a significant fraction of such relatively long grains is beneficial, is explained below.

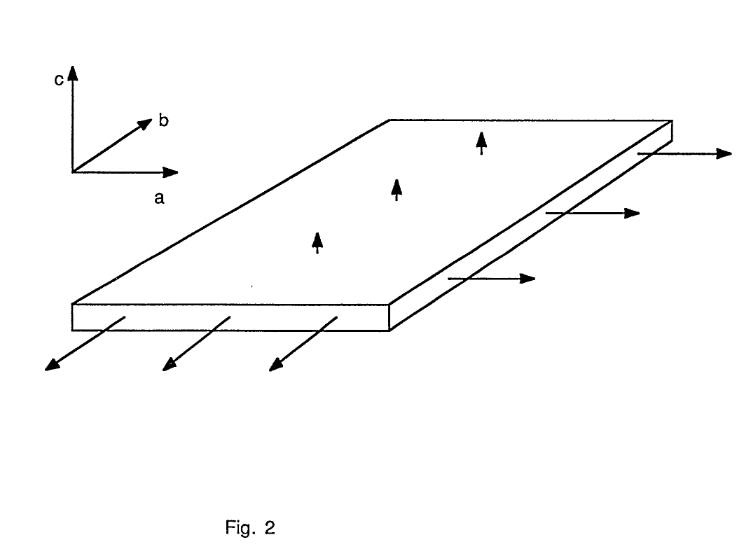

Deforming the metallic precursor to a long, thin filament allows for the preparation of high-T_{c} superconducting oxides with enhanced electrical properties. It is hypothesized that a preferred alignment of high-T_{c} superconducting oxide grains can be produced by the growth of such oxide grains obtained from the oxidation of long, thin filaments of metallic precursor. As mentioned above, there is an anisotropy in growth rate that exists in high T_{c} superconducting oxides such that growth is fastest in directions parallel to the crystallographic a-b plane of the unit cell. Thus, high T_{c} oxide grains tend to grow so as to become plate-like or disk-like in shape, where the thin grain dimension is parallel to the slow growing, crystallographic c direction. (See FIG. 2). The invention also takes advantage of the fact that there exists an anisotropy with respect to superconduction. Supercurrent flows most readily in high T_{c} oxides in directions parallel to the crystallographic a-b planes. In addition to producing a significant fraction of grains that are longer than 1/10 the thin dimension of the wire, as explained below, the invention produces a significant fraction of superconducting oxide grains that have a long dimension in the direction of elongation (which is also the direction of operationally required supercurrent) that also lies in the preferred a-b plane of greatest superconductivity. It will be understood that the superconductor is used in a device such that the direction of required supercurrent is parallel to the direction of elongation.

The driving force for grain growth is a reduction in the interfacial free energy associated with curved grain boundaries. Hillert proposed the following general equation for normal grain growth.

dRᵢ/dt=aᵢMᵢsᵢ[(1/R_{cr})−(1/Rᵢ)] (1)

where Rᵢ is the radius of grain i at time t, R_{cr} is the critical grain radius at time t (related to the average grain size), Mᵢ is the grain boundary mobility, sᵢ is the grain boundary energy density, and aᵢ is a dimensionless constant (related to grain shape). M. Hillert, Acta Met., Vol. 13, 1965, pg. 227. From eqn. 1, grains with an average radius larger than the critical radius grow, while grains smaller than the critical radius shrink. In other words, during normal grain growth, the average grain size increases by the process of larger grains consuming smaller grains.

A variation in the rate of grain growth with crystallographic orientation is due to a variation in sᵢ, or Mᵢ (or both) with crystallographic orientation. A preferred crystallographic alignment of the superconducting oxide grains can be achieved by imposing a geometric constraint on such anisotropic grain growth, as discussed below.

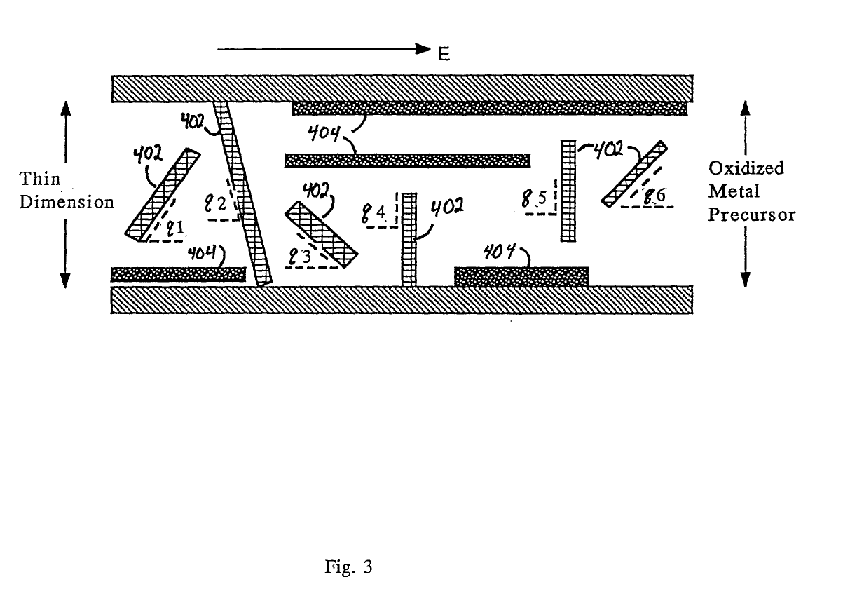

FIG. 3 shows a two-dimensional schematic of a sheathed metallic precursor tape. The tape possesses one thin dimension, and two long dimensions. One of the long dimensions is the operationally-required direction of bulk superconduction, which is indicated by the direction E. During heat treatment, superconducting oxide grains nucleate at various locations in the elongated body. Nucleation may yield a variety of grain orientations as shown in FIG. 3. For simplicity, the grains shown in FIG. 3 are assumed to be disk-like in shape, with the crystallographic a-b plane of the oxide parallel to the plane of the disk. The cross-sections of the disk-like grains are shown in FIG. 3. It is assumed in this example that grains grow much faster in directions parallel to the a-b plane, than in the c direction; that is, that the disk-like grains grow rapidly in radial directions and thicken slowly. Grains 402, that are oriented at angles q(1-6) with respect to the container walls 460, can continue growing (in a manner described by eqn. 1) until they intercept the container wall. Grains 404, that are oriented parallel to the container walls can continue growing (in a manner described by eqn. 1) unimpeded by the container. Thus, after a sufficient period of grain growth, the grains 404 can become larger in radius than grains 402. If the radii of grains 402 is smaller than the critical radius, grains 402 will shrink and eventually disappear. Thus, the constraint provided by the container walls will cause a shift in the distribution of grain orientations, so that the volume fraction of properly-oriented grains increases with increased annealing time. In other words, the c-axis orientation of a second significant fraction of grains will become aligned in a direction parallel to the thin dimension of the tape. Such grain alignment is highly desirable, because the operationally-required direction of superconduction lies parallel to the a-b planes of the grains, which are the preferred planes for superconduction.

In the ideal case, the fraction of grains so aligned will include most of, and will be approximately equal to, or slightly less than the first significant fraction of grains discussed above, having a length greater than 1/10 the thin dimension of the filament. A preferred embodiment of the superconductor of the invention has a second significant fraction of aligned grains that is also greater than or equal to the percolation limit for superconduction along a path composed solely of such long and aligned grains. In a preferred embodiment, such a significant fraction will exceed 0.15 and in a most preferred embodiment, it will exceed 0.5.

C-axis tilt and twist boundaries may remain, however, even with perfect c-axis alignment. The critical current density resulting from electrical transport across random high-angle c-axis tilt or twist grain boundaries may be relatively low. However, the critical current transported between such grains can be relatively high, provided that such grain boundaries possess a large area. The critical current is related to critical current density by the following simple expression.

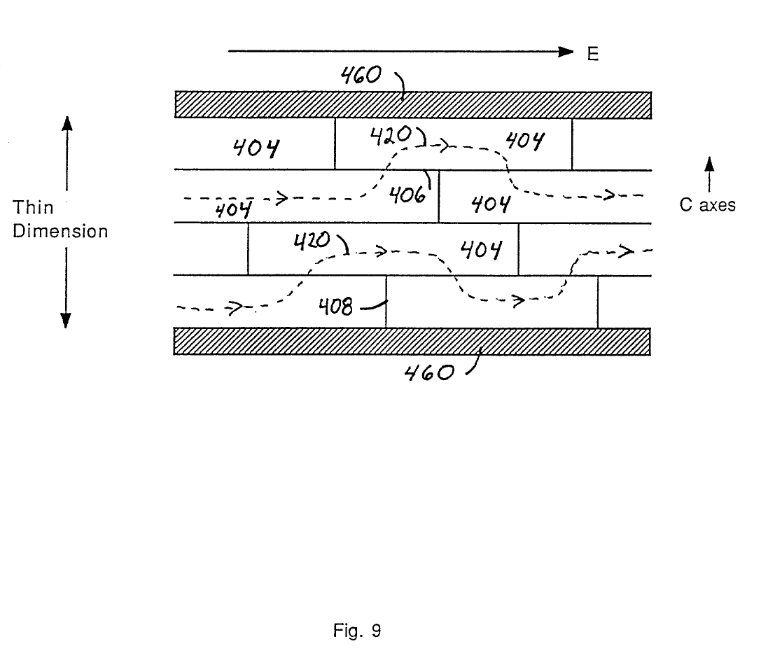

I_{c}=J_{c}.A (2)

where J_{c} and I_{c} are the critical current density and critical current, respectively, and A is the cross-sectional area through which supercurrent flows. Thus, if J_{c} between misoriented grains is relatively small, I_{c} can still be relatively large if the common area shared by the grains is large. As shown schematically in FIG. 9, an interconnected path 420 travels across such large area grain boundaries 406, and around small-area grain boundaries 408. (see A. P. Malozemoff, High Temperature Superconducting Compounds II, S. H. Whang, A. Dasgupta, R. Laibowitz, eds., TMS, Warrendale, PA, 1990, pg. 3 incorporated by reference herein) Thus, superconducting tapes with a second significant fraction of grains with c-axis alignment may carry large supercurrents, despite the presence of some c-axis tilt or twist grain boundaries. As discussed above, one can obtain such c-axis alignment by constraining the anisotropic grain growth of oxides in one or more dimensions.

The high T_{c} superconducting oxides (e.g., cuprate superconductors in the RE—Ba—Cu—O, (Pb,Bi)—Sr—Ca—Cu—O, and Tl—Ba—Ca—Cu—O systems, where RE refers to rare-earth elements) exhibit grain growth anisotropy that results in the formation of aspected grains with a thin dimension parallel to the crystallographic c direction. Geometrically constrained grain growth of these oxides results in an enhancement of c-axis grain alignment. It is further believed that any superconducting compound (oxides or non-oxides) that exhibits grain growth anisotropy can be aligned by geometrically constraining grain growth in one or more dimensions. While the foregoing discusses the ideal case where the c-axes of all of the grains are parallel to each other and the thin dimension of the elongated superconductor, enhanced superconducting properties can be obtained in less ideal situations where the c-axes of all of the grains are substantially aligned and make a small angle relative to each other and to the direction of the thin dimension of the elongated superconductor. See Dimos et al, identified above. A preferred angle of misalignment is less than 30° and a most preferred angle of misalignment is less than 10°.

To summarize the foregoing, an important factor in obtaining a high degree of c-axis grain alignment is the ratio of the length of the grains to the size of the thin dimension(s) of the geometric constraint. It is desired that, after annealing, at least a significant fraction of superconducting oxide grains have at least one long dimension that is at least one-tenth the thickness of the thin dimension of the deformed container. If so, then at least a second significant fraction of superconducting oxide grains will also be aligned such that their c-axis is parallel to the thin dimension of the deformed container. The phrase “a significant fraction” refers to the critical volume fraction of grains that are required to allow for supercurrent to flow along an interconnected path consisting only of such long grains.

The foregoing discussion with respect to FIGS. 3, 8, and 9 has focused on a single, elongated superconductor, formed by deforming a single container. However, it is a significant aspect of the invention to provide a plurality of such bodies, thereby arriving at the favorable crack resistant properties of a laminate in addition to the favorable superconducting properties of the crystallographically-aligned body discussed above.

Several of such shaped bodies can be repacked into another inert metallic container and reshaped, so as to form a multifilamentary body. Silver, gold, or silver-gold alloys are examples of relatively inert materials for the Y—Ba—Cu—O and Pb—Bi—Sr—Ca—Cu—O superconductors.

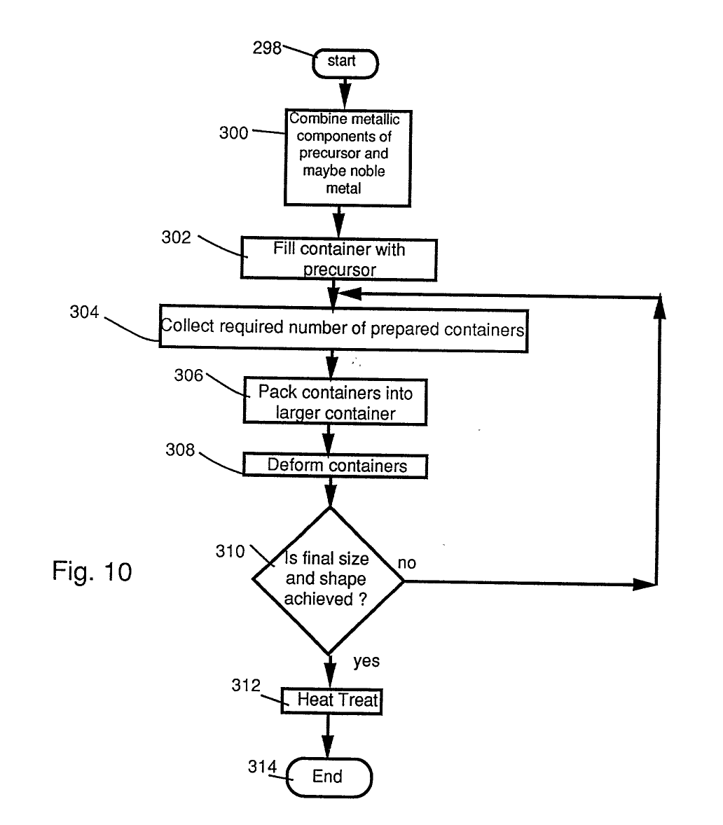

Rather than following step 104 of FIG. 8 directly with the step 106 of heat treating the container, it is beneficial to prepare a number of such containers, as shown in FIG. 10, step 304, and to pack those containers into a larger, inert container, step 306. This results in a body such as 58a, shown in FIG. 6. This nested body is deformed 308 by any of the methods mentioned above, so that it is elongated, and the dimensions of the individual interior containers perpendicular to the direction of elongation are reduced. At this point, the deformed, nested body may be heat treated as discussed above.

However, it is beneficial to provide additional degrees of nesting and deforming before heat treatment, as shown at step 310. A number of deformed, nested bodies such as 58a of FIG. 6 are packed within an inert container to form a body such as 62, shown in FIG. 7, having two degrees of nesting. The resulting body is itself deformed, thereby further elongating the bodies nested within and further reducing one or more of the dimensions perpendicular to the elongations. The deformed body may be heat treated at this point, or it may be incorporated into another body of even greater degree of nesting. As will be readily understood by one of ordinary skill in the art, the degree of nesting can be increased to greater and greater degrees, depending upon the ductility, elasticity and other parameters of the precursor and the inert containers. Ultimately, when the desired final size and shape are achieved, the body is heat treated at step 312, as discussed above.

The invention can be further described with reference to the following examples.

### EXAMPLE 1

Metallic Y, Ba, Cu and Ag are mechanically alloyed in a high-energy ball mill. The ratio of metal species is Y:Ba:Cu:Ag=1:2:3:X, where X>0. The all-metal powder is packed into a silver tube. The tube is welded shut. The tube is then hydrostatically extruded at 300° C. into a hexagonal cross-section wire. Several of such deformed tubes are repacked into another silver tube. This multifilament tube is then hydrostatically extruded at 300° C. Several of these multifilament tubes may again be repacked into another silver tube and hydrostatically extruded at 300° C. This packing-deforming-repacking-deforming . . . process is repeated until at least one dimension of each filament core is less than 100 microns in thickness, and preferably, less than 10 microns in thickness. The multifilament tube is then heated to 500° C. in an oxygen-bearing atmosphere to completely oxidize the metals. The tube is then heated to 920° C. for 400 hours to form the tetragonal version of YBa₂Cu₃O₇₋ₓ. The time at 920° C. should is selected so as to produce a significant fraction of YBa₂Cu₃O₇₋ₓ grains with a length greater than or equal to 10 microns. The tube is then annealed at 500° C. in an oxygen-bearing atmosphere so as to form the superconducting orthorhombic version of YBa₂Cu₃O₇₋ₓ.

### EXAMPLE 2

Metallic Y and Ba are mechanically alloyed in a high-energy ball mill. The Y and Ba powder are placed inside a copper tube, which is, in turn, placed inside a silver tube. The thickness of the copper tube and the amount of Y and Ba powder added are such that the ratio of Y:Ba:Cu in the silver tube is 1:2:4. The silver tube is welded shut. The tube is then hydrostatically extruded at 300° C. into a hexagonal cross-section wire. Several of such deformed tubes are re-packed into another silver tube. This multifilament tube is then hydrostatically extruded at 300° C. Several of these multifilament tubes may again be repacked into another silver tube and deformed. This packing-deforming-repacking-deforming . . . process is repeated until at least one dimension of each filament core is less than 100 microns in thickness, and preferably, less than 10 microns in thickness. The multifilament tube is then heated to 400-600° C. in an oxygen-bearing atmosphere to completely oxidize the metals. The tube is then heated to 700-835° C. for 20-400 hours to form YBa₂Cu₄O₈. The time at 700-835° C. should be sufficiently long so as to produce a significant fraction of YBa₂Cu₄O₈ grains with a length greater than or equal to 10 microns.

### EXAMPLE 3

An alloy of composition YBa₂Cu₃ is produced by mechanical alloying in a ball mill and then blending in Ag powder. The molar ratio of metal species in the blend is Y:Ba:Cu:Ag=1:2:3:X, where X>0. The all-metal powder is packed into a silver tube. The tube is welded shut. The tube is then hydrostatically-extruded at 300° C. into a hexagonal cross-section wire. Several of such deformed tubes are re-packed into another silver tube. This multifilament tube is then hydrostatically extruded at 300° C. Several of these multifilament tubes are again repacked into another silver tube and hot extruded. This packing-deforming-repacking-deforming . . . process is repeated as described above until at least one dimension of each filament core is less than 100 microns in thickness and preferably, less than 10 microns in thickness. The multifilament tube is then heated to 400-600° C. in an oxygen-rich atmosphere to completely oxidize the metals. The tube is then heated to 700-940° C. for 20-400 hours to form the tetragonal version of YBa₂Cu₃O₇₋ₓ. The time at 700-940° C. should be sufficiently long so as to produce a significant fraction of YBa₂Cu₃O₇₋ₓ grains with a length greater than or equal to 10 microns. The tube is then annealed at 350-600° C. in an oxygen-bearing atmosphere so as to form the superconducting orthorhombic version of YBa₂Cu₃O₇₋ₓ.

### EXAMPLE 4

Ribbons of composition YbBa₂Cu₃ are produced by melt-spinning (rapid-solidification of the molten alloy). The YbBa₂Cu₃ ribbons are packed into a silver tube with the long dimension of the ribbon parallel the long dimension of the tube. The packing is conducted by stacking alternating layers of YbBa₂Cu₃ ribbon and silver ribbon. The tube is welded shut. The tube is then hot rolled into a tape geometry. Several of such deformed tapes are re-packed into another silver tube. This multifilament tube is then hot rolled into a tape geometry. Several of these multifilament tapes may again be repacked into another silver tube and hot rolled. This packing-deforming-repacking-deforming core. .process is repeated until at least one dimension of each filament core in the tape is less than 100 microns in thickness and preferably, less than 10 microns in thickness. The multifilament tape is then heat treated as was the body in Example 3 to form the superconducting orthorhombic version of YBa₂Cu₃O₇₋ₓ.

### EXAMPLE 5

A thick film comprised of layers of Y, Ba, and Cu is deposited, by plasma spraying, onto a silver substrate. The ratio of metal species in the film is Y:Ba:Cu=1:2:3. The coated silver substrates are packed into a silver tube. The packing is conducted to produce alternating layers of Y—Ba—Cu film and silver substrate. The tube is welded shut. The tube is then hot-pressed into a tape geometry. Several of such pressed tapes are re-packed into another silver tube. This packing-deforming-repacking-deforming core . . . process is repeated until at least one dimension of each filament core in the tape is less than 100 microns in thickness and preferably, less than 10 microns in thickness. The multifilament tape is then heat treated as was the body of Example 3 to form the superconducting orthorhombic version of YBa₂Cu₃O_{7-z}.

### EXAMPLE 6

A mechanical alloy of Sr₂Ca₁ and/or elemental Sr+Ca are blended with a mechanical alloy consisting of two or more of the species Bi, Cu, and Ag and/or elemental Bi, and Cu. The ratio of the metal species in the blend is Bi:Sr:Ca:Cu=2:2:1:2. The all-metal powder is packed into a silver tube. The tube is welded shut. The tube is then hot pressed into a tape geometry. Several of such deformed tubes are re-packed into another silver tube, which is then hot pressed into a tape. This packing-deforming-repacking-deforming . . . process is repeated until at least one dimension of each filament core is less than 100 microns in thickness and preferably, less than 10 microns in thickness. The tape is then heated to 400-600° C. in an oxygen-bearing atmosphere so as to completely oxidize the metals. The tape is then heated to 700-940° C. so as to form the superconducting oxide Bi₂Sr₂Ca₁Cu₂O_{z}. The time at 700-940° C. should be sufficiently long so as to produce a significant fraction of Bi₂Sr₂Ca₁Cu₂O_{z} grains with a length that is greater than or equal to 10 microns.

### EXAMPLE 7

A mechanical alloy of Bi₂Sr₂Ca₁Cu₂ is blended with elemental Ag. The ratio of the metallic species is Bi:Sr:Ca:Cu:Ag=2:2:1:2:X, where 0<X<50. The all-metal powder is packed into a silver tube. The tube is welded shut. The tube is then hydrostatically extruded at 300° C. into a tape geometry. Several of such deformed tubes are repacked into another silver tube, which is then hot hydrostatically extruded into a tape. This packing-deforming-repacking-deforming . . . process is repeated until at least one dimension of each filament core is less than 100 microns in thickness and preferably, less than 10 microns in thickness. The tape is then heat treated as was the body of Example 6 to form the superconducting oxide Bi₂Sr₂Ca₁Cu₂O_{z}.

### EXAMPLE 8

Mechanically-alloyed Sr−Ca and/or a simple blend of elements Sr+Ca is mixed with a mechanical alloy of Cu−Ag and/or a simple blend of elements Cu+Ag and a mechanical alloy of Bi−Pb and/or a simple blend of elements Bi+Pb. The ratio of the metal species in the blend is Bi:Pb:Sr:Ca:Cu:Ag=1.5:0.5:2:2:3:X, where X=0-50. The all-metal powder is packed into a silver tube. The tube is welded shut. The tube is then hot-pressed into a tape geometry. The deformation is conducted at a temperature above the melting point of one or more phases of the precursor (125° C.-328° C.). Several of such deformed tubes are re-packed into another silver tube, which is then hot-pressed at a temperature above the melting point of one or more phases of the precursor. This packing-deforming-repacking-deforming . . . process is repeated until at least one dimension of each filament core is less than 100 microns in thickness and preferably, less than 10 microns in thickness. The tape is heated to 400-600° C. in an oxygen-bearing atmosphere so as to completely oxidize the metals. The wire is then heated to 700-940° C. so as to form the superconducting oxide (Bi,Pb)₂Ca₂Cu₃O_{z}. The time at 700-940° C. should be sufficiently long so as to produce a significant fraction of (Bi,Pb)₂Ca₂Cu₃O_{z} grains that are greater than or equal to 10 microns in length. A final oxygenation anneal at 350-600° C. is then conducted on the tape to maximize the critical temperature, below which resistance=0 of this superconductor.

### EXAMPLE 9

A composite body is produced by placing a rod of metallic copper inside a tube comprised of an alloy or blend of yttrium and barium metals. The ratio of Y:Ba of the tube is 1:2. The diameter of the copper rod and the thickness of the Y-Ba tube are such that the overall composite body has a Y:Ba:Cu ratio of 1:2:3. The rod-in-tube structure is then packed into a silver can and welded. The tube is then extruded into a wire geometry. Several of such deformed composite tubes are repacked into another silver tube. This multifilament tube is then extruded. Several of these multifilament tubes may again repacked into another silver tube and extruded. This packing-deforming-repacking-deforming core . . . process is repeated until at least one dimension of each filament core is less than 100 microns in thickness and preferably, less than 10 microns in thickness. The multifilament tube is then heat treated as was the body of Example 3 to form the superconducting orthorhombic version of YBa₂Cu₃O₇₋ₓ.

### EXAMPLE 10

A copper rod is packed, along with a blend of Ba and Y powder, or mechanically-alloyed Ba—Y powder or rapidly-solidified powders of Ba and Y, in a silver tube. The ratio of Y:Ba in the tube is 1:2. The diameter of the copper rod and the amount of Y—Ba powder added to the silver tube are such that the overall composite body has a Y:Ba:Cu ratio of 1:2:3. The silver tube, containing the powders and rod, is then welded shut. The tube is then extruded into a wire geometry. Several of such deformed tubes are re-packed into another silver tube. This packing-deforming-repacking-deforming . . . process is repeated until at least one dimension of each filament core is less than 100 microns in thickness and preferably, less than 10 microns in thickness. The multifilament tube is then heat treated as was the body of Example 3 to form the superconducting orthorhombic version of YBa₂Cu₃O₇₋ₓ.

### EXAMPLE 11

The rod-in-tube method of Examples 9 and 10 can be applied to the Bi—Sr—Ca—Cu system. The Y and Ba are replaced with Ca and Sr, with the Ca:Sr ratio being 2:1. The copper rod is replaced with a Bi—Cu rod with an elemental ratio of 2:2 for Bi:Cu. The Bi—Cu rod and the Ca—Sr tube or Ca—Sr powder are placed inside a silver tube such that the overall metallic precursor core has a Bi:Sr:Ca:Cu radio of 2:2:1:2. The deformation cycle described in examples 9 and 10 remains the same. The post-deformation heat treatment is the same as described in Example 6.

### EXAMPLE 12

The rod-in-tube method of Examples 9 and 10 can be applied to the Pb—Bi—Sr—Ca—Cu system. The Y and Ba are replaced with Ca and Sr, with the Ca:Sr ratio being 2:2. The copper rod is replaced with a Pb—Bi—Cu rod with an elemental ratio of 2-X:X:3 for Bi:Pb:Cu, where X is in the range of 0-0.5. The Pb—Bi—Cu rod and the Ca—Sr tube or Ca—Sr powder are placed inside a silver tube such that the overall metallic precursor core has a Pb:Bi:Sr:Ca:Cu radio of X:2-X:2:2:3. The deformation cycle described in examples 9 and 10 remains the same. The post-deformation heat treatment is the same as described in Example 8.

It is also possible to provide superconducting bodies having very thin conductors where the precursor to the superconductor is combined with a noble element, as defined above in connection with the Yurek patent. The noble element can be combined so that it is intimately mixed with the precursor. As a result of heat treatment, the noble metal precipitates as a finely divided substantially pure metal phase intimately mixed with the superconducting oxide.

The presence of the noble metal intimately mixed with the oxide superconductor phase generally improves the mechanical properties of the superconductor, rendering the oxide-metal composite more resistant to cracks and other failures. The present invention minimizes the need to improve the mechanical properties to some extent, because the metal sandwiched between the layers of laminated or concentric or otherwise deformed superconductor provide some desirable mechanical properties, such as rigidity, strength, etc. However, the superconducting oxide remains brittle and susceptible to fracture. The presence of the noble metal intimately mixed with the superconducting oxide phase will reduce the tendency for crack propagation. However, a trade-off arises because the noble metal may obstruct the oriented growth of oxide grains described above. It would be a matter of routine experimentation for one of ordinary skill in the art to determine the amount of noble metal that would provide any required degree of improvement in mechanical properties, without a serious degradation of the superconducting properties.

### EXAMPLE 13

The methods of Examples 9 to 12 may be conducted with Ag present in the metal precursor rods or tubes or powders.

As has been discussed, a principal advantage of the invention is that it provides a body having superconducting oxide grains oriented with a preferred crystallographic direction aligned with operationally-defined direction of bulk supercurrent. It is believed that this beneficial grain alignment is most pronounced for thin geometries in the form of wires, rods, tapes, etc. In applications where sheet-like superconductors are required, a sheet can be formed with superconducting oxide grains oriented so that the crystallographically preferred plane for superconduction is aligned coplanar to the plane of the sheet. Thus, it is within the purview of the invention to deform the superconductor by rolling, pressing, etc. into flat sheet-like geometries.

The present invention may also be employed in conjunction with the invention described in Applicant's co-pending patent application, entitled “A Process for Making Ceramic/Metal and Ceramic-Ceramic Laminates by Oxidation of a Metal Precursor,” filed in the name of Kenneth H. Sandhage on Apr. 3, 1991, U.S. Ser. No. 679,614, which is incorporated herein by reference. In summary, that invention relates to oxidizing a noble-metal-bearing metal precursor body under conditions of alternating higher and lower oxygen partial pressure and/or lower and higher temperature. Such an oscillating heat treatment (referred to as oscillating oxidation herein) results in alternating oxidized zones composed of relatively high and low concentrations of superconducting oxide grains. This oscillating oxidation can be applied to contained, noble-metal-bearing metallic precursor bodies of the type discussed above, so as to create finer divisions of superconducting oxide and metal than had already been created by successive applications of deformation and repacking. The method of oscillating oxidation can be applied to the precursor either at the point when mechanical deformation is completed, or before. By combining the two techniques, very thin filaments of superconducting material can be constrained to grow between nonsuperconducting layers. The ultra thin layers allow for the growth of superconducting oxide grains with preferred crystallographic orientations, as discussed above. Thus, an aspect of the apparatus of the invention is a superconducting body having elongated, thin superconducting zones, where the superconducting zones are bounded by metallic container walls and/or regions with low concentrations of superconducting oxide (high concentrations of nonsuperconductor), resulting from oscillating oxidation.

It is an aspect of the method of the invention to apply the oscillating oxidation heat treatment to the superconducting body as a replacement of step 106 as shown in FIG. 8. It will be understood that the oscillating oxidation heat treatment can be applied to either a single superconducting body, such as shown on FIG. 5, or a nested body, such as shown in FIG. 7.

The foregoing discussion should be taken as illustrative and not limiting in any sense.

Having described the invention, what is claimed is:

1. An elongated superconducting body comprising:
a. a core of superconducting oxide grains said core having at least one thin first dimension that is less than or equal to 10 times the average length of said superconducting oxide grains of a first significant fraction in said core; and
b. a constraining non-superconducting boundary member substantially circumscribing the superconducting core.

2. An elongated superconducting body comprising at least one high temperature superconducting assembly, each assembly having at least one innermost superconducting assembly, each innermost superconducting assembly comprising:
a. a plurality of cores of high temperature superconducting oxide grains, said cores having at least one thin first dimension that is less than or equal to 10 times the average length of said superconducting oxide grains of a first significant fraction in said cores, each core also being substantially circumscribed by a constraining non-superconducting boundary member; and
b. a constraining non-superconducting boundary member substantially circumscribing the plurality of superconducting cores.

3. A metallic precursor body for heat treating to form an elongated superconducting oxide body said precursor comprising:
a. a core of the metallic elements of said superconducting oxide in substantially the stoichiometric proportions to form said superconducting oxide, said core having at least one thin first dimension that is less than or equal to 10 times the average length of superconducting oxide grains of a first significant fraction that form upon heat treatment of said metallic precursor body; and
b. a constraining non-superconducting boundary member substantially circumscribing the metallic precursor core.

4. A method of fabricating an elongated superconducting body comprising the steps of:
a. providing a metallic precursor core of the metallic elements of said superconducting oxide in substantially the stoichiometric proportions to form said superconducting oxide;
b. providing a constraining non-superconducting boundary member substantially circumscribing the metallic precursor core;
c. deforming the combined metallic precursor core and boundary member to an elongated shape, having at least one thin first dimension;
d. heat treating said deformed combined precursor core and boundary member so as to produce a first significant fraction of oxide superconductor grains of said precursor core having an average length that is greater than one-tenth said thin first dimension of the deformed metallic precursor core.

5. A method of fabricating an elongated, superconducting body having at least one assembly of superconducting cores comprising the steps of:
a. repeating the following steps i and ii until a predetermined number of cores are prepared:
i. providing a metallic precursor core of the metallic elements of said superconducting oxide in substantially the stoichiometric proportions to form said superconducting oxide; and
ii. providing a constraining non-superconducting boundary member substantially circumscribing the metallic precursor core;
b. associating a predetermined number of contained cores into at least one innermost assembly of cores;
c. for each at least one innermost assembly, providing a constraining non-superconducting boundary member sized to substantially circumscribe the assembled contained cores;
d. deforming each at least one innermost assembly so that it becomes thinner in at least one first dimension;
e. repeating the following steps i-iv until the predetermined degree of nesting is achieved:
i. associating a predetermined number of deformed assemblies of predetermined degrees of nesting in a predetermined configuration;
ii. providing a constraining non-superconducting boundary member sized to substantially circumscribe the associated deformed assemblies;
iii. packing the associated deformed assemblies into said circumscribing boundary member to form an intermediate assembly of greater degree of nesting than the deformed assemblies being packed; and
iv. deforming the greater degree intermediate assembly so that it becomes thinner in at least one first dimension; and
f. heat treating said deformed assembly of predetermined degree of nesting so as to produce a first significant fraction of superconducting oxide grains of at least one said precursor cores, said superconducting oxide grains having an average length that is greater than or equal to one-tenth the at least one thin first dimension of the deformed cores.

6. A method of fabricating a metallic precursor for an elongated, superconducting body having at least one assembly of superconducting cores comprising the steps of:
a. repeating the following steps i and ii until, a predetermined number of cores are prepared:
i. providing a metallic precursor core of the metallic elements of said superconducting oxide in substantially the stoichiometric proportions to form said superconducting oxide; and
ii. providing a constraining non-superconducting boundary member substantially circumscribing the metallic precursor core;
b. associating a predetermined number of contained cores into at least one innermost assembly of cores;
c. for each at least one innermost assembly, providing a constraining non-superconducting boundary member sized to substantially circumscribe the assembled contained cores;
d. deforming each at least one innermost assembly so that it becomes thinner in at least one first dimension; and
e. repeating the following steps i-iv until the predetermined degree of nesting is achieved:
i. associating a predetermined number of deformed assemblies of predetermined degrees of nesting in a predetermined configuration;
ii. providing a constraining non-superconducting boundary member sized to substantially circumscribe the associated deformed assemblies;
iii. packing the associated deformed assemblies into said circumscribing boundary member to form an intermediate assembly of greater degree of nesting than the deformed assemblies being packed; and
iv. deforming the greater degree intermediate assembly so that at least one first thin dimension of at least one of said metallic precursor cores is less than or equal to 10 times the average length of superconducting oxide grains of a first significant fraction that form upon heat treatment of the metallic precursor cores.

7. The superconducting body of claim 1 wherein said average length of said superconducting oxide grains of said first significant fraction is greater than one-half of the at least one thin first dimension of said core.

8. The superconducting body of claim 1 wherein said average length of said superconducting oxide grains of said first significant fraction is greater than said at least one thin first dimension of said core.

9. The superconducting body of claim 1 wherein said superconducting oxide grains comprise unit cells having a long dimension, the c dimension, and a and b dimensions both of which are shorter than the long c dimension, and said oxide grains exhibit a superconductive anisotropy, with the superconductivity in the a-b plane defined by the two shorter dimensions being the highest, said superconducting body further comprising a second significant fraction of grains aligned so that a vector perpendicular to a direction parallel to said thin first dimension of said superconducting body lies parallel to the a-b planes of the grains.

10. The superconducting body of claim 9 wherein said second significant fraction is greater than or equal to 0.15.

11. The superconducting body of claim 1 wherein said second significant fraction is greater than or equal to the percolation limit for superconduction along a path composed solely of said second significant fraction of superconducting oxide grains.

12. The superconducting body of claim 2, each assembly further comprising at least one intermediate superconducting assembly, each intermediate assembly comprising a plurality of innermost superconducting assemblies.

13. The superconducting body of claim 1, wherein said superconducting oxide comprises thallium.

14. The superconducting body of claim 1, wherein said superconducting oxide comprises bismuth.

15. The superconducting body of claim 1, wherein said superconducting oxide comprises copper.

16. The superconducting oxide body of claim 1 wherein said core further comprises a noble metal.

17. The method of claim 4 wherein said metallic precursor core is deformed such that at least one dimension of said core is smaller than 100 microns.

18. The superconducting oxide body of claim 1 wherein said non-superconducting boundary member comprises metal.

19. The superconducting body of claim 1 wherein said superconducting oxide grains comprise unit cells having a long dimension, the c dimension, and a and b dimensions both of which are shorter than the long c dimension, and said oxide grains exhibit a superconductive anisotropy, with the superconductivity in the a-b plane defined by the two shorter dimensions being the highest, said superconducting body further comprising a second significant fraction of grains aligned so that a vector perpendicular to a direction parallel to said thin first dimension of said superconducting body lies at an angle inclined less than 30° to the a-b planes of the grains.

20. The superconducting body of claim 19, where said vector perpendicular to a direction parallel to said thin first dimension of said superconducting body lies at an angle inclined less than 10° to the a-b planes of the grains.
